(19) United States
(12) Patent Application Publication
(10) Pub. No.: US 2007/0228147 A1
(43) Pub. Date: Oct. 4, 2007

(54) APPLICATION GENERATION SYSTEM, METHOD AND MACHINE READABLE MEDIUM

(75) Inventors: Kirwan Lyster, London (GB); Mat Williams, Kent (GB)

Correspondence Address: DARBY & DARBY P.C., P.O. BOX 770, Church Street Station, New York, NY, 10008-0770, US

(73) Assignee: Reporo Limited, London (GB)

(21) Appl. No.: 11/277,977

(22) Filed: Mar. 30, 2006

(51) Int. Cl. G07F 19/00

(52) U.S. Cl. 235/379

(57) ABSTRACT

An application generation system, method and machine readable medium are disclosed. A repository is used to store user data in an electronic wallet. Upon creation of an electronic wallet in the repository, the application generation system is operative to generate an application, the application being linked to the electronic wallet and arranged to access the contents of the electronic wallet to fulfill actions initiated via the application.

### FIELD OF THE INVENTION

The present invention relates to an application generation system, method and machine readable medium, and in particular to a system, method and machine readable medium in which a generated application is linked to a remote repository.

### BACKGROUND TO THE INVENTION

Data privacy and security is an issue of growing concern to computer users, particularly those who access remote computer systems over insecure data communications networks such as the Internet.

One way of increasing security and simplifying use of remote computer systems is by the use of electronic wallets. In a computer system using electronic wallets, data is held at the remote system on behalf of the user in a repository referred to as an electronic wallet. Upon accessing the remote system, the user is able to access the data in the wallet for use in the remote system. One example use of an electronic wallet is in an e-commerce application. In e-commerce applications, address and credit card details are held in electronic wallets so that when the user wishes to make a purchase, those details do not need to be re-entered. Not only does this save time but it also increases security as credit card information does not need to be repeatedly sent over insecure data communications networks. Access to an electronic wallet is typically controlled by password protection to prevent others accessing data held on behalf of a user.

Whilst such systems work well when accessed via a personal computer (PC), or similar, they typically are not flexible enough to handle access via other channels. One particular channel that many commentators expected to develop much more than it has is mobile telephony. While most adults and teenagers in the developed world have a mobile telephone, very few use the full data communications functionality of their phones. Even with the advent of 2.5G and 3G mobile phone networks that support data connections of bandwidth similar to those provided by PCs, users are reluctant to use their mobile phones for anything other than making phone calls. The main reasons for this reluctance arise from limitations in the user interfaces provided by remote systems (in particular websites) to mobile telephones and also difficulties with input devices provided by the mobile phones. Many systems do not provide user interfaces written with the small screen size and limited keypad of mobile phones in mind. Even those that do are normally written for mainstream mobile phones and may not be displayed properly on all makes and models. While many mobile phones include functionality to scale user interfaces to fit on screen or allow scrolling, even if the user-interface is successfully translated for use on the mobile phone, the tedium of navigating and entering data via the mobile phone's keypad puts most users off.

### STATEMENT OF INVENTION

According to one aspect of the present invention, there is provided an application generation system comprising a repository for storing user data in an electronic wallet, wherein upon creation of an electronic wallet in the repository, the application generation system is operative to generate an application, the application being linked to the electronic wallet and arranged to access the contents of the electronic wallet to fulfill actions initiated via the application.

User information is stored in an electronic wallet remote to the user for future use. An application is linked to the electronic wallet and provided to a device nominated by the user in such a way that the user information is accessed as needed when the application is used on the device. This considerably reduces the effort required by the end-user to get the system up and running on the device, and also enables the application to operate in a way that is customised to the user.

Embodiments of the present invention seek to extend the use of electronic wallets. Upon creation of an electronic wallet, a software application is provided to the user that is lined to the electronic wallet and is arranged to use data contained within the electronic wallet during its operation. Preferably, the software application is for use on another platform to that used to generate the electronic wallet. For example, the electronic wallet could be generated using a PC accessing a remote website. The software application could be transmitted to the user's mobile phone allowing the user to subsequently use the software application on the mobile phone. When the software application is used, data is obtained from the electronic wallet (which is stored remotely to the mobile phone).

For example, the software application could access an e-commerce web site (which may or may not be the web site used to generate the electronic wallet). In this scenario, address data and credit card data may have already been entered into the electronic wallet via the PC (which is much simpler and more user friendly than using the data entry keypad of the mobile phone). When accessing the e-commerce site using the software application, data from the electronic wallet is automatically used to fulfil orders. Entering data via a PC is much easier than using the limited keypads of a mobile phone. Capturing personal and financial details entered in the event of transaction being completed on the retailers web-site and using this data to automatically populate a wallet for later use via an application on the mobile phone is time saving for the user and requires much less effort. By using data shared in a centrally stored wallet, the amount of re-keying required by a new user setting up an account is effectively eliminated. In addition, once created, a wallet can be used with any of the retailers linked to the system. In effect the user only has to create the wallet for the first retailer and all subsequent transactions with any retailer will use the originally inputted data. Accessing the wallet is preferably controlled via a four digit pin number. Other access scenarios such as limiting access to the wallet from only certain mobile phone numbers can be envisaged.

In another example, the software application may be an email client. Data on the user's email account and settings are entered into an electronic wallet in a manner discussed above and stored on a remote system. Upon generation of the wallet, a software application linked to the wallet is provided to the user. when run, the software application accesses the wallet and obtains the data and settings which it subsequently uses to access the user's email account and send/receive emails.

According to another aspect of the present invention, there is provided a method of generating a computer application comprising:

storing user data in an electronic wallet; and,

generate an application dependent on the electronic wallet, wherein the application is linked to the electronic wallet and arranged to access the contents of the electronic wallet to fulfill actions initiated via the application downloading the application onto a first platform;

running the application on the first platform;

inputting data for creating the electronic wallet into the application at the first platform; and,

transmitting the electronic wallet to a repository.

According to another aspect of the present invention, there is provided a machine readable medium having stored thereon a computer program, said computer program comprising a set of instructions which, when executed, cause the machine to perform the steps of:

storing user data in an electronic wallet; and,

generating an application dependent on the electronic wallet, wherein the application is linked to the electronic wallet and arranged to access the contents of the electronic wallet to fulfill actions initiated via the application.

### BRIEF DESCRIPTION OF THE DRAWINGS

Embodiments of the present invention will now be described in detail, by way of example only, with reference to the accompanying drawings in which:

FIG. 1 is a schematic diagram of an application generation system according to an embodiment of the present invention;

FIG. 2 is a schematic diagram illustrating operation of an application according to an embodiment of the present invention generated by the system of FIG. 1;

FIG. 3 is an example portion of HTML code suitable for capturing users data upon completion of a transaction on a website; and,

FIG. 4 is a schematic diagram of a system according to another embodiment of the present invention;

### DETAILED DESCRIPTION

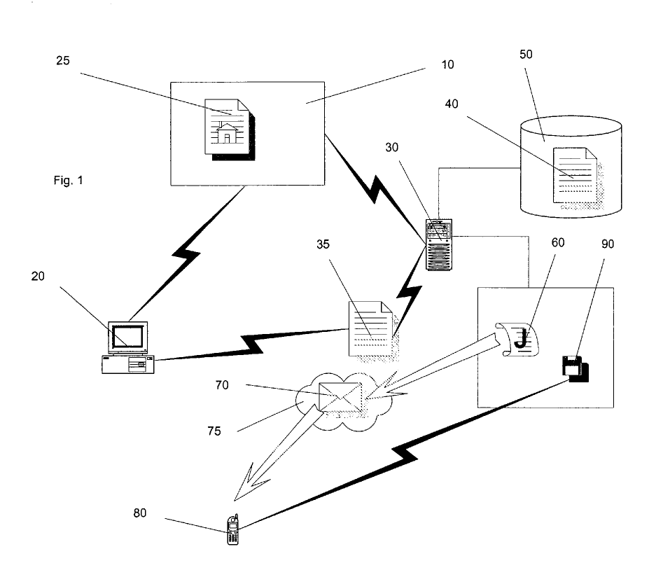

FIG. 1 is a schematic diagram of an application generation system according to an embodiment of the present invention.

An e-commerce site 10 is accessible via a remote client 20. Upon access, the site 10 provides a user interface 25 in the form of a web page to the remote client 20. The user interface 25 provides a user at the remote client 20 with access to the e-commerce site 10. Using the user interface 25, the user can navigate the e-commerce site 10 and select products and/or services for purchase. When the user selects to finalise his or her order, a check out page is provided via the user interface 25. The user enters his or her name, delivery and invoice addresses and credit card information into the check out page and submits this information to the site 10 to finalise the order.

Upon receipt of the information, the site 10 communicates via the user interface 25, offering the user the opportunity to receive a custom application for accessing the site and associated sites via a mobile phone. If the user accepts, the user information is passed to an application generation system 30. The application generation system 30 communicates with the user via a user interface 35 to obtain any information needed in addition to that provided by the site 20. In particular, the application generation system obtains a user password/PIN and the user's mobile phone number. An electronic wallet 40 is created from the information and is stored in a repository 50.

The application generation system 30 generates a data file 60 and stores it at a location accessible to the user's mobile telephone 80. The data file contains details about the application and some user specific information used to link the application to the electronic wallet 40. The location of the data file 60 is then transmitted using a simple messaging service (SMS) message 70 via a mobile telephone network 75 to the user's mobile telephone 80. Preferably, the SMS message includes a link in the form of a URL to the data file 60.

Preferably, the data file 60 is a Java application descriptor (JAD) file. Installation of the application begins when the end-user opens the URL on his or her mobile phone 80. When the user's mobile phone obtains the JAD file 60 via the URL, the Java Application Manager (JAM) on the user's phone 80 is directed by data in the JAD file 60 to a Java Archive (JAR) file 90 stored on the application generation system 30. The JAR file 90 contains the code of the application and is downloaded by the JAM and used to install the application on the phone 80. The JAM handles all management of the application such as security verification, installation, upgrade and/or removal. During installation, data from the data file 60 is used to configure the application. Configuration includes setting a user identifier (assigned earlier by the application generation system 30) that associates the application with the wallet 40.

Optionally, during installation, details on the user's mobile telephone handset may be obtained. These details may be used by the application generation system to assess the requirement for application software upgrade and may also be used to select a particular application in the event different applications are produced to suit different handsets.

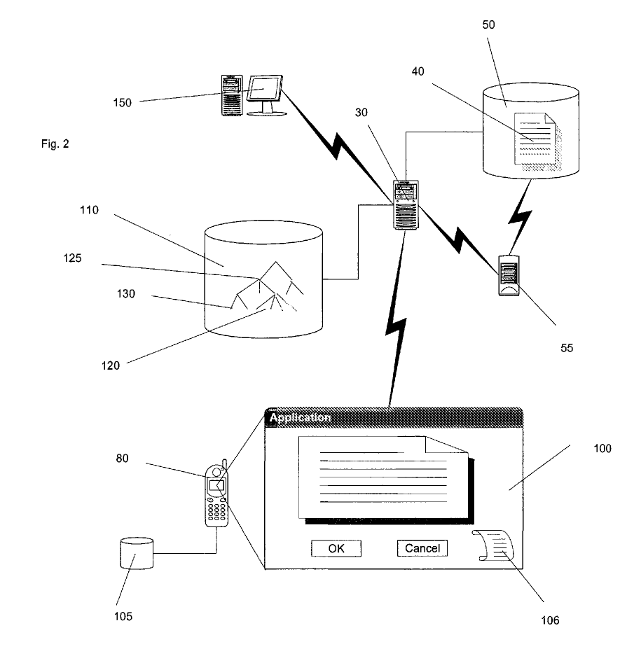

FIG. 2 is a schematic diagram illustrating operation of an application according to an embodiment of the present invention generated by the system of FIG. 1.

Upon installation, the user will find an icon on his or her mobile phone 80 which represents the application 100. When the application 100 is launched, it contacts application generation system 30 to log the user in. This is performed using the user identifier and the password/PIN previously defined by the user during creation of the wallet 40. The identifier and password are verified by the application generation system 30. Optionally, the software version of the application may be checked to see if an upgrade is available, if so the user is informed and offered a new download.

Upon verification, the application 100 provides a user interface suited for use on the mobile phone 80 and written for streamlined communication with the application generation system 30. The first screen displayed by the user interface includes a list of industries. Selecting one of these causes a list of retail partners to be displayed. For each industry there are a number of retail partners set up to display their content. Selecting one of these retail partners allows the user to enter that partner's shopping portal. Each portal carries the retail partner's logo and content. The logos and content of the respective retail partners is stored by the application generation system 30 in a database 110. The content is arranged in a tree structure 120 and is organised in a manner selected by the retail partner. Content is updated by the retail partners on a regular basis. Traversing the content tree structure 120 allows the end-user to browse the content, the inner parts 125 of the tree structure are menus and the outer leaves 130 of the structure are pages. Pages may be informational such as Help/Contact/About or product. The product pages contain all the necessary information to allow the user to make an informed buying decision.

Attributes for a product may be defined within (or associated to) the content. Attributes are special pieces of data which are indexed by the application generation system 30 and allow the user to search the product catalogue for associated items in a convenient manner. An example might be the recording artist in terms of an audio CD, in which case selecting this item will produce search results for the Artist—i.e. display all CDs available by that artist.

The user interface is streamlined to reduce the amount of data input required by the user, which in turn speeds up navigation of the content and provides an improved browsing environment. Furthermore, the communications overhead with the application generation system 30 is reduced in comparison to web browsers and the like as only content and structure data is transmitted to the application 100—formatting and other functionality is coded within the application 100.

The product pages may also allow for options to be specified, these options might include a selection for small, medium or large and such like. Selecting different options may affect the price of the item. The options use familiar controls such as radio buttons, checkboxes and text fields.

The content held in the database 110 is retrieved on demand by the application 100. Once a page has been retrieved it is placed in cache 105 for fast retrieval should it be required again. At predetermined times, content over a predetermined age is removed from the cache 105. The cache 105 persists for the lifetime of a session.

The application 100 also preferably provides a free text search functionality, whereby the user will enter a search term and wait for results. Selecting a result takes the user to the product page for that item.

User preferences may be used to customise the content of the application such that industries can be removed or pre-configured searches placed into a Mysearches folder. These preferences are preferably created through a web interface allowing access to the wallet 40 for updating its content and specifying preferences and the like.

Items may be added to a shopping basket or bought immediately. When requesting a purchase, the user is again as asked to enter his/her password/PIN. Upon receiving a request for a purchase from the application 100, the application generation system 30 contacts the respective retail partner's system 150 to determined availability. If the item is available, a hold request is submitted by the application generation system 30 so that it is not sold to another party. The application generation system 30 then processes the transaction using payment data stored in the wallet 40. Assuming the transaction is successful, the application generation system 30 instructs the retail partner's system 150 to arrange delivery of the item t the address held in the wallet 40. Should the item not be available or the transaction fail, the user is informed via the application 100.

Preferably, password/PIN is a series of characters which may consist of digits or letters (not special characters) and should be at least four characters in length.

The application generation system 30 preferably provides a meta-wallet 106 to the application when the user logs on. The meta-wallet 106 is an abridged version of the wallet 40 supplying enough detail to allow the user to select the card and delivery address (assuming multiple cards and/or addresses are specified in the wallet 40) required for the transaction. The user selects the required options and then hits confirm, at this point the transaction is sent for processing.

Sensitive data is never sent to the mobile phone 80, the wallet 40 is preferably held in an encrypted format. The key which unlocks the wallet 40 is preferably stored at on a key server 55 which is a physically different system to the application generation system 30, thereby making the database 50 itself useless to an attacker. The Key Server 55 preferably communicates only with the application generation system 30.

Preferably, access to the Key Server 55 is restricted to a small set of known IP addresses. Even if an attacker has data from both databases the indexing system is such that there is not direct reference between the wallet 40 and the key. This is achieved using an MD-5 hash which incorporates the password/PIN which is never permanently stored. The more users there are the harder the database index is to crack. Furthermore the key itself is not stored in a plain format, it is encrypted using the password/PIN and some salt (entropy data) which is stored in a secret format. Each key has randomly generated salt values so an attacker could not extract the salt through key data comparisons.

When a transaction is sent for processing the entire process of wallet decryption must be performed, the correct card and address details selected and the transaction authorised by a relevant financial institution. This all happens in a few seconds and the user is then presented with confirmation which includes unique identifiers for this transaction.

The user is also emailed a copy for their records.

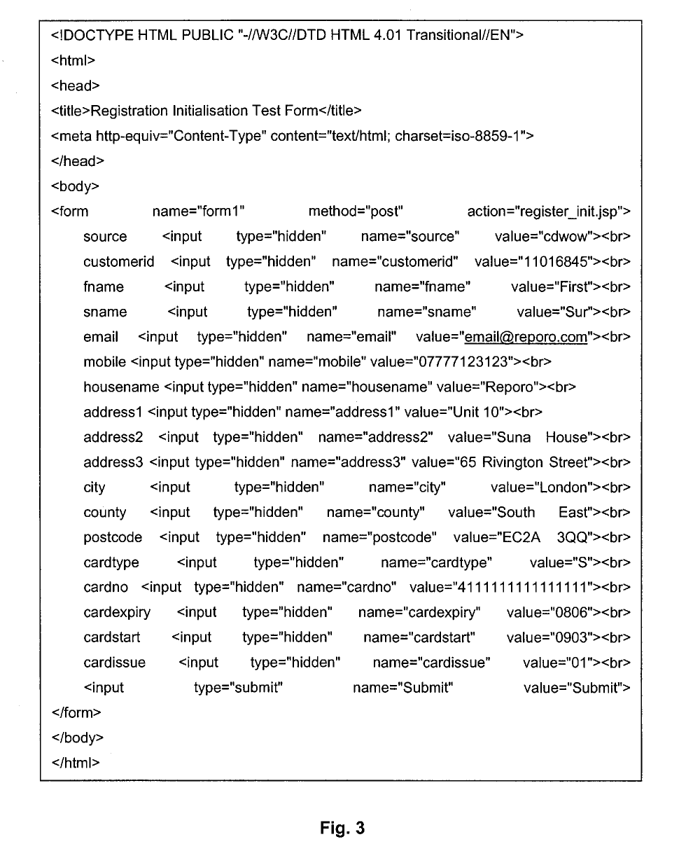

Preferably, each retail partner also maintains their own ecommerce website that invites purchasers to obtain a mobile application in a manner such as discussed above with reference to FIG. 1. To achieve this, HTML code, such as that illustrated in FIG. 3, is placed at the closing stages of a transaction. The code includes variables to transfer common transaction values, such as name, credit card details and addresses. These values are populated dynamically from the user session by the retail partner's web/application server. This code is ideally placed on the retail partner's order ‘Thank You’ page.

When the end-user completes their transaction and arrives at the ‘Thank You’ page he/she is preferably presented with a button which allows them to join the user base. Upon activation the details are sent via a secure communication channel to systems using form submit over HTTPS.

The application generation system 30 preferably inspects the content of every request to register before the process begins in earnest. If a request is found to contain data provided via a retail partner then the process is optimised as described. Requests to register can be made without performing a transaction at a retail partner's site. For example, the application generation system may itself run a web site allowing direct registration.

The inspection process involves checking for the presence of valid query string data and extracting values to their relevant variables in the user registration session. Retail partner specific data such as customer reference is placed within the user profile for that retailer in the wallet 40. This type of data is used for loyalty schemes and CRM systems. The submission may also carry retail partner identity values. Such values may be used to customise the registration pages so that they are branded with the retail partner's details and logo thereby making the process appear fully consistent to the end-user.

The user is able to revisit their preferences at any time and modify them as required.

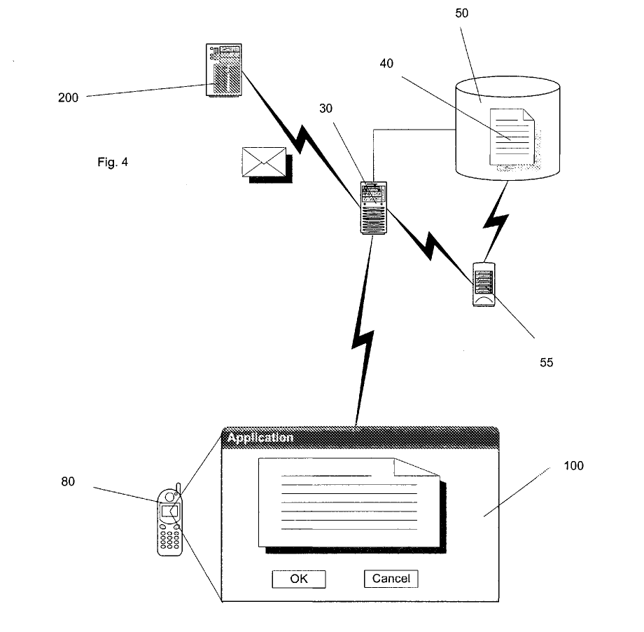

FIG. 4 is a schematic diagram of a system according to another embodiment of the present invention.

Instead of e-commerce functionality, the application 100 provided to the mobile phone 80 may provide other functionality. In the embodiment of FIG. 3, the application is an email client.

Upon registration with the application generation system 30, the user is prompted for details of his or her email account(s). In the case of a POP3 email account, these details will include the addresses of incoming (POP3) and outgoing (SMTP) mail servers, the user's user name for accessing the email account and the password associated with the account. The details are stored in a wallet 40 in the repository 50 and, as in the embodiments discussed above, and application 100 is installed onto the user's phone 80 that is linked to the wallet 40.

When the application 100 is run, it logs onto the application generation system 30 using the user identifier and password as above. The wallet 40 is then accessed and the application 100 is then provided with a list of email accounts that can be accessed using the data in the wallet 40. Upon selection of an account, the application generation system contacts the email server 200 and logs on behalf of the user using the user's user ID and password for that email account. Any new emails are downloaded (or copied) and presented to the user via the application 100. Replies can be made in a similar manner using the application 100.

The application generation system 30 in this embodiment is operated by a separate entity to email providers and is able to act as a central point of access to multiple accounts. However, embodiments of the present invention can be envisaged where the application generation system 30 itself is an email provider, in which case the user details would already be known to it and not extra input (beyond a mobile phone number) would be needed as data could be transferred from its records to the wallet 40.

It will be appreciated that embodiments of the present invention could be directed to many applications. For example, the application could be for remote access/control of a remote computer system. In this case user ID, passwords and addresses of the remote computer system would be stored in the wallet 40, the application generation system 30 acting as the intermediate between the application 100 on the mobile phone and the remote computer system. In a similar manner to that discussed with reference to FIG. 3, the application generation system 30 would log onto the remote computer system on behalf of the user and relay images of the remote computer system's screen to the application 100. Similarly, inputs from the application 100 would be relayed via the application generation system 30 to the remote computer system.

In all of the above examples, sensitive data does not need to be repeatedly entered by a user—it is stored in a wallet and linked to a custom application. Data from the wallet is used as is needed but need not be transmitted over insecure communication lines such as a mobile telephone network. All links between the application generation system 30 and retail partner systems, email servers, remote computers etc could be via secure sessions. Similarly, the application generation system 30 is in control of data sent to the application and can filter/format it to reduce bandwidth and speed up operation. As the application is customised for the user and the intended purpose, only the bare minimum data needs to be transmitted between the application 100 and the application generation system 30.

It will be appreciated that although wallet creation, application generation and subsequent operation is handled by the application generation system in the above described embodiments, this is not essential and different system may perform the respective operations. For example, one system may perform wallet creation and maintenance, another application generation and another subsequent operation. Similarly, a number of systems may handle subsequent operation with the information provided in the data file 60 defining which system is to be contacted by the respective application 100.

Although embodiments of the present invention have focused on applications for mobile telephones, it will be appreciated that embodiments of the present invention could be used for other platforms including personal computers, PDAs, internet-enabled appliances, etc.

In an alternative embodiment, a user may be able to download, or otherwise obtain, an application to their mobile telephone. When executed on the mobile telephone, the application enables creation of a wallet on the phone, the wallet being linked to the application as discussed above. The created wallet is then transmitted by the telephone to the repository 50. Subsequent transactions then operate as discussed above.

1. An application generation system comprising a repository for storing user data in an electronic wallet, wherein upon creation of an electronic wallet in the repository, the application generation system is operative to generate an application, the application being linked to the electronic wallet and arranged to access the contents of the electronic wallet to fulfill actions initiated via the application.

2. A system according to claim 1, further comprising a user interface arranged to accept data for creating the electronic wallet from a first platform, wherein the application is arranged to operate on a second platform.

3. A system according to claim 2, wherein the first and second platforms are of different platform types.

4. A system according to claim 2, wherein the application generation system is arranged to communicate with the second platform to enable installation of the application on the second platform.

5. A system according to claim 4, wherein the second platform is a mobile telephone.

6. A system according to claim 5, wherein the application generation system is arranged to communicate a location of the application to the second platform via a simple messaging service message.

7. A system according to claim 1, wherein the application is arranged to connect to a database of products and/or services and provide e-commerce functionality, the wallet storing address and payment data associated with the user for fulfillment of transactions initiated using the application.

8. A system according to claim 7, wherein the wallet is created upon completion of a transaction on a web site.

9. A system according to claim 1, wherein the application comprises an email client, the wallet including user data and access data for one or more email accounts associated with the user, the system further comprising an intermediary arranged to accept instructions from the application and access one or more of the email accounts using data in said wallet on behalf of the user.

10. A system according to claim 1, wherein the application comprises a remote computer system access system, the wallet including user access data for accessing a remote computer system, the system further comprising an intermediary arranged to accept instructions from the application, access the remote computer system using data in said wallet, relay screen data from said remote computer system to said application and relay remote control commands from said application to said remote computer system.

11. A method of generating a computer application comprising:
storing user data in an electronic wallet; and,
generating an application dependent on the electronic wallet, wherein the application is linked to the electronic wallet and arranged to access the contents of the electronic wallet to fulfill actions initiated via the application.

12. A method according to claim 11, further comprising:
accepting data for creating the electronic wallet from a first platform, wherein the application is arranged to operate on a second platform.

13. A method according to claim 12, further comprising:
communicating with the second platform to enable installation of the application on the second platform.

14. A method according to claim 11, further comprising:
creating the wallet upon completion of a transaction on a web site.

15. A method according to claim 11, further comprising:
downloading the application onto a first platform;
running the application on the first platform;
inputting data for creating the electronic wallet into the application at the first platform; and,
transmitting the electronic wallet to a repository.

16. A machine readable medium having stored thereon a computer program, said computer program comprising a set of instructions which, when executed, cause the machine to perform the steps of:
storing user data in an electronic wallet; and,
generating an application dependent on the electronic wallet, wherein the application is linked to the electronic wallet and arranged to access the contents of the electronic wallet to fulfill actions initiated via the application.

17. A machine readable medium according to claim 16, further comprising instructions which, when executed, cause the machine to perform the steps of:
accepting data for creating the electronic wallet from a first platform, wherein the application is arranged to operate on a second platform.

18. A machine readable medium according to claim 17, further comprising instructions which, when executed, cause the machine to perform the steps of:
communicating with the second platform to enable installation of the application on the second platform.

19. A machine readable medium according to claim 16, further comprising instructions which, when executed, cause the machine to perform the steps of:
creating the wallet upon completion of a transaction on a web site.

20. A machine readable medium according to claim 16, further comprising instructions which, when executed, cause the machine to perform the steps of:
downloading the application onto a first platform;
running the application on the first platform;
accepting data for creating the electronic wallet into the application at the first platform; and,
transmitting the electronic wallet to a repository.
